(19) United States
(12) Patent Application Publication
(10) Pub. No.: US 2019/0211860 A1
(43) Pub. Date: Jul. 11, 2019

(54) JOINT ASSEMBLY FOR FURNITURE

(71) Applicant: Lei Yang, City of Industry, CA (US)

(72) Inventor: Lei Yang, City of Industry, CA (US)

(73) Assignee: FURNITURE OF AMERICA, INC., City of Induatry, CA (US)

(21) Appl. No.: 15/868,170

(22) Filed: Jan. 11, 2018

(51) Int. Cl. F16B 12/24; F16B 12/12

(52) U.S. Cl. CPC F16B 12/24; F16B 12/125

(57) ABSTRACT

A joint structure includes a first connecting unit, a second connecting unit, and a securing member. The first connecting unit has a distal end portion, a proximate end portion, and a connecting surface formed on the proximate end portion. The second connecting unit has a coupling surface and a connecting slot formed on the coupling surface. The securing member is configured to securely connect the first and second connecting units, so when the proximate end portion of the first connecting unit is inserted into the connecting slot of the second connecting unit, the securing member is configured to lock up the first and second connecting units. The joint structure is configured to prevent lateral rotational movement between the first and second connecting units and to reinforce the furniture structure having such joint structure, especially when an excessive load is applied to the distal end of the connecting unit.

### FIELD OF THE INVENTION

The present invention relates to furniture, and more particularly to a joint structure for furniture that is configured to securely interlock furniture connecting members of the furniture.

### BACKGROUND OF THE INVENTION

Conventionally, structural frames in furniture are made by assembling a plurality of furniture members such as wooden panels or beams that can be connected with each other and interlocked by interlocking devices, e.g. corner joints. Corner joints can usually be used to construct temporary connections and facilitate assembly and disassembly of furniture members.

There are several disadvantages for conventional furniture corner joints. For example, the corner joints may be used in bed frames and when the bed is moved or shaken periodically, the bolts used for the corner joints may not be securely tightened, which causes the connection between the bed frame members to become loose and the entire structure of the bed frame may be weakened.

Also, when an excessive load is applied to the corner portion of the bed frame members near the corner joint, it becomes weak and may be broken easily, especially when the load is applied to the distal end of the frame member, which may also cause the connection between the bed frame members to become loose because the bolts to provide the connection may fail.

Furthermore, one bed frame member may be rotated with respect to the other bed frame member because the interlocking means for the bed frame members may only be used for preventing the bed frame members from detaching from each other, but not preventing one from rotating with respect to the other. Therefore, there remains a need for a new and improved joint structure to overcome the problems stated above.

### SUMMARY OF THE INVENTION

It is an object of the present invention to provide a furniture joint structure to strengthen the structure of furniture, especially the corner portion thereof.

It is another object of the present invention to provide a furniture joint structure to prevent lateral rotational movement between furniture frame members.

It is a further object of the present invention to provide a furniture joint structure to reinforce the structure of furniture, especially when an excessive load is applied to the distal end of the frame member.

In one aspect, a joint structure may include a first connecting unit, a second connecting unit, and a securing member. The first connecting unit has a distal end portion, a proximate end portion and a connecting surface formed on the proximate end portion. The second connecting unit has a coupling surface and a connecting slot formed on the coupling surface, wherein the size of the connecting slot is slightly larger than the proximate end portion of the first connecting unit. In one embodiment, the connecting slot can be used to receive the proximate end portion of the first connecting unit.

The securing member is configured to securely connect the first connecting unit and the second connecting unit, so when the proximate end portion of the first connecting unit is inserted into the connecting slot of the second connecting unit, the securing member is configured to detachably lock up the first connecting unit with the second connecting unit. Namely, the first connecting member and the second connecting member are detachably conjugated by the securing member, wherein the connecting surface is arranged to bias against the second connecting member for substantially withstanding a load applied on the distal end portion of the first connecting member. In other words, the load applied to the first connecting unit can be substantially resisted by connecting surface of the first connecting unit when the proximate end portion of the first connecting unit is inserted into the connecting slot of the second connecting unit.

The proximate end portion of the first connecting unit has a cross sectional size smaller than that of the second connecting unit for inserting into the connecting slot of the second connecting unit to define the connecting surface for biasing against a corresponding surface in the connecting slot. Thus, when the proximate end portion of the first connecting unit has been inserted into the connecting slot of the second connecting unit, the first connecting unit is interlocked and substantially retained by the securing member. Also, the first connecting unit is prevented from rotating with respect to the second connecting unit. It is important to note that each of the proximate end portion and the connecting slot has a non-circular cross section so as to prevent lateral rotational movement between the first connecting unit and the second connecting unit.

Moreover, in order to ensure secure retention of the proximate end portion within the connecting slot, a predetermined length L of the proximate end portion is substantially equal to a depth of the connecting slot so as to allow the proximate end portion of the first connecting unit to be fittedly inserted into the second connecting unit.

The securing member may include at least one coupling slot indentedly and longitudinally formed inside the first connecting unit, and at least one connecting shaft extended from the connecting slot of the second connecting member. In one embodiment, both the coupling slot and the connecting shaft are threaded, so when the connecting shaft is inserted into the coupling slot, the connecting shaft can be threadedly secured therein.

More specifically, the connecting shaft is configured to penetrate the proximate end portion and be securely tightened within the coupling slot. The securing member further has an interlocking hole formed on the connecting surface to communicate with the coupling slot, wherein the connecting shaft is adapted to pass through the interlocking hole to be threadedly tightened within the coupling slot.

It is worth mentioning that the connecting shaft extends from an inner surface of the connecting slot of the second connecting unit in such a manner that the proximate end portion can be fittedly received into the connecting slot while the connecting shaft extends to pass through the interlocking hole and be threadedly secured within the coupling slot.

It is important to mention that the securing member can be embodied as any other arrangement which is capable of interlocking the first connecting unit with the second connecting unit.

The joint structure can be used for a bed frame, which may have a plurality of first connecting beams, a plurality of second connecting beams, and a plurality of securing members. Like the joint structure discussed above, the securing member is configured to interlock the first connecting beam and the second connecting beam. Similarly, the securing member may include at least one coupling slot indentedly and longitudinally formed inside the first connecting beam, and at least one connecting shaft extended from a connecting slot of the second connecting beam. In one embodiment, both the coupling slot and the connecting shaft are threaded, so when the connecting shaft is inserted into the coupling slot, the connecting shaft can be threadedly secured therein to securely interlock the first connecting beam and the second connecting beam.

Comparing with conventional joint structure, the present invention is advantageous because conventional joint structure is extremely vulnerable to damage. In the present invention, the corner portion is substantially reinforced by the second connecting unit because any loading applied to the distal end portion of the first connecting unit is supported by the corresponding inner surface of the connecting slot. The load is therefore uniformly distributed and resisted by the second connecting unit. Also, since each of the proximate end portion and the connecting slot has a non-circular cross section so as to prevent lateral rotational movement between the first connecting unit and the second connecting unit.

### BRIEF DESCRIPTION OF THE DRAWINGS

FIG. 1 is an exploded view of the joint structure in the present invention.

FIG. 2 illustrates a schematic view of the first connecting unit and the second connecting unit in the present invention.

FIG. 3 illustrates a schematic view of the joint structure in the present invention when the first connecting unit is not fully inserted into the second connecting unit.

FIG. 4 illustrates a schematic view of the joint structure in the present invention when the first connecting unit is securely connected with the second connecting unit.

FIG. 5 illustrates a schematic view of the joint structure in the present invention used in a bed frame.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

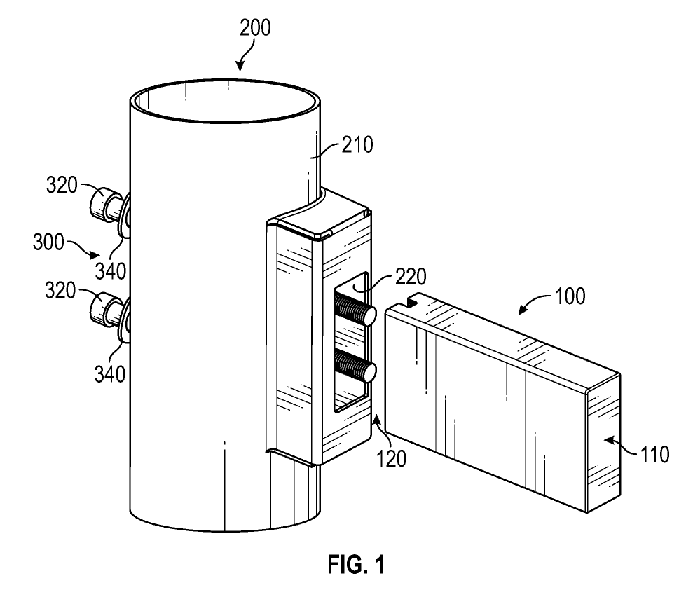

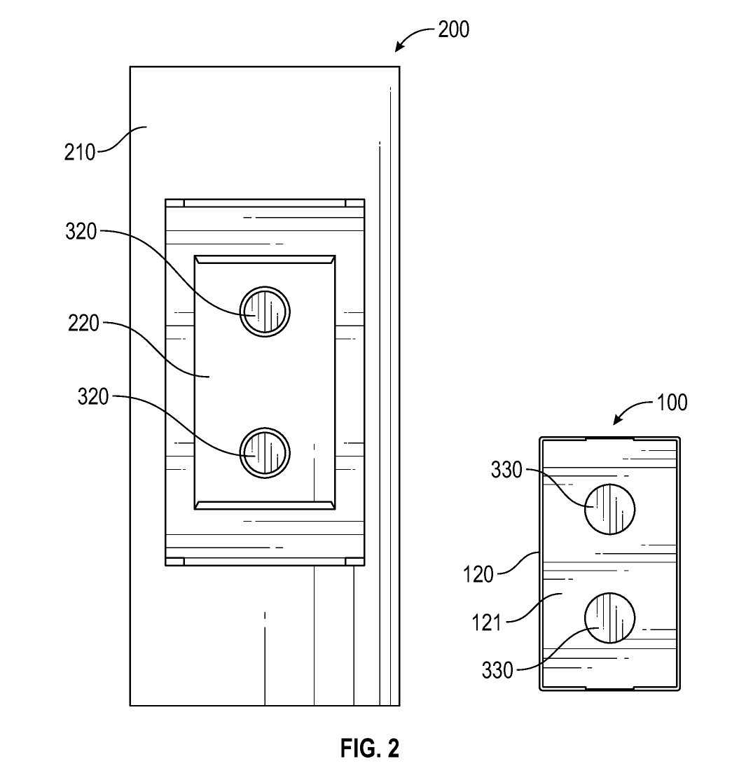

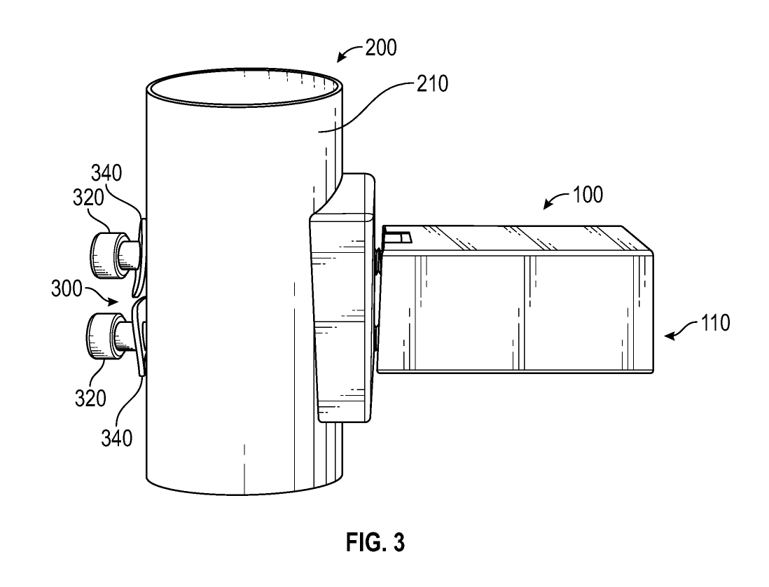

In one aspect, referring to FIGS. 1 to 4, a joint structure may include a first connecting unit 100, a second connecting unit 200, and a securing member 300. The first connecting unit 100 has a distal end portion 110, a proximate end portion 120 and a connecting surface 121 formed on the proximate end portion 120. The second connecting unit 200 has a coupling surface 210 and a connecting slot 220 formed on the coupling surface 210, wherein the size of the connecting slot 220 is slightly larger than the proximate end portion 120 of the first connecting unit 100. In one embodiment, the connecting slot 220 can be used to receive the proximate end portion 120 of the first connecting unit 100.

The securing member 300 is configured to securely connect the first connecting unit 100 and the second connecting unit 200, so when the proximate end portion 120 of the first connecting unit 100 is inserted into the connecting slot 220 of the second connecting unit 200, the securing member 300 is configured to detachably lock up the first connecting unit 100 with the second connecting unit 200. Namely, the first connecting member 100 and the second connecting member 200 are detachably conjugated by the securing member 300, wherein the connecting surface 121 is arranged to bias against the second connecting member 200 for substantially withstanding a load applied on the distal end portion 110 of the first connecting member 100. In other words, the load applied to the first connecting unit 100 can be substantially resisted by connecting surface 121 of the first connecting unit 100 when the proximate end portion 120 of the first connecting unit 100 is inserted into the connecting slot 220 of the second connecting unit 200. In one embodiment, the joint structure is made by metal.

The proximate end portion 120 of the first connecting unit 100 has a cross sectional size smaller than that of the second connecting unit 200 for inserting into the connecting slot 220 of the second connecting unit 200 to define the connecting surface 121 for biasing against a corresponding surface in the connecting slot 220. Thus, when the proximate end portion 120 of the first connecting unit 100 has been inserted into the connecting slot 220 of the second connecting unit 200, the first connecting unit 100 is interlocked and substantially retained by the securing member 300. Also, the first connecting unit 100 is prevented from rotating with respect to the second connecting unit 200. It is important to note that each of the proximate end portion 120 and the connecting slot 220 has a non-circular cross section so as to prevent lateral rotational movement between the first connecting unit 100 and the second connecting unit 200.

Moreover, in order to ensure secure retention of the proximate end portion 120 within the connecting slot 220, a predetermined length L of the proximate end portion 120 is substantially equal to a depth of the connecting slot 220 so as to allow the proximate end portion 120 of the first connecting unit 100 to be fittedly inserted into the second connecting unit 200.

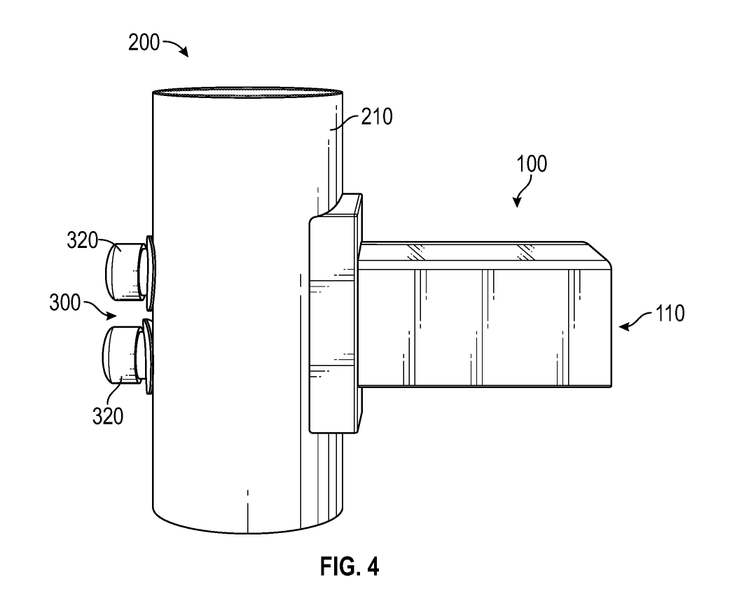

The securing member 300 may include at least one coupling slot 310 indentedly and longitudinally formed inside the first connecting unit 100, and at least one connecting shaft 320 extended from the connecting slot 220 of the second connecting member 200. In one embodiment, both the coupling slot 310 and the connecting shaft 320 are threaded, so when the connecting shaft 320 is inserted into the coupling slot 310, the connecting shaft 320 can be threadedly secured therein as shown in FIG. 4.

More specifically, the connecting shaft 320 is configured to penetrate the proximate end portion 110 and be securely tightened within the coupling slot 310. The securing member 300 further has an interlocking hole 330 formed on the connecting surface 121 to communicate with the coupling slot 310, wherein the connecting shaft 320 is adapted to pass through the interlocking hole 330 to be threadedly tightened within the coupling slot 310.

It is worth mentioning that the connecting shaft 320 extends from an inner surface of the connecting slot 220 of the second connecting unit 200 in such a manner that the proximate end portion 120 can be fittedly received into the connecting slot 220 while the connecting shaft 320 extends to pass through the interlocking hole 330 and be threadedly secured within the coupling slot 310.

It is important to mention that the securing member 300 can be embodied as any other arrangement which is capable of interlocking the first connecting unit 100 with the second connecting unit 200.

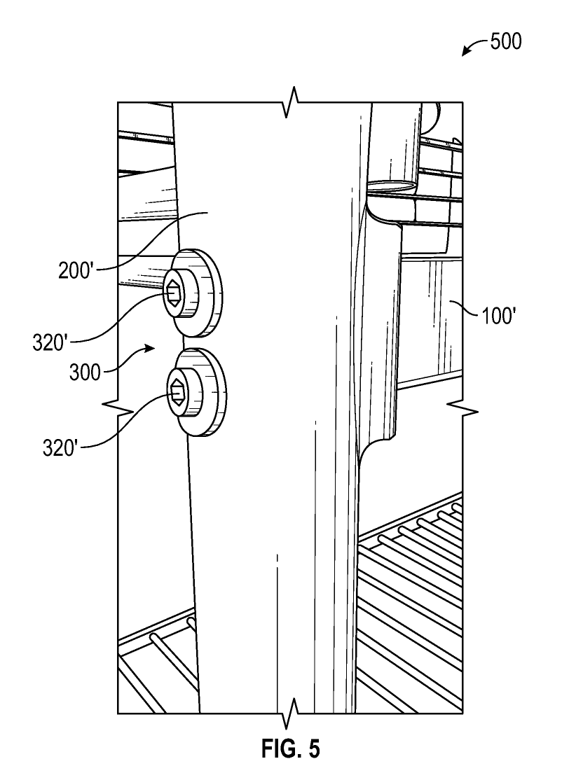

As shown in FIG. 5, the joint structure can be used for a bed frame 500. The bed frame may have a plurality of first connecting beams 100′, a plurality of second connecting beams 200′, and a plurality of securing members 300′. Like the joint structure discussed above, the securing member 300′ is configured to interlock the first connecting beam 100′ and the second connecting beam 200′. Similarly, the securing member 300′ may include at least one coupling slot 310′ indentedly and longitudinally formed inside the first connecting beam 100′, and at least one connecting shaft 320′ extended from a connecting slot 220′ of the second connecting beam 200′. In one embodiment, both the coupling slot 310′ and the connecting shaft 320′ are threaded, so when the connecting shaft 320′ is inserted into the coupling slot 310′, the connecting shaft 320′ can be threadedly secured therein to securely interlock the first connecting beam 100′ and the second connecting beam 200′.

Comparing with conventional joint structure, the present invention is advantageous because conventional joint structure is extremely vulnerable to damage. In the present invention, the corner portion is substantially reinforced by the second connecting unit 200 because any loading applied to the distal end portion 110 of the first connecting unit 100 is supported by the corresponding inner surface of the connecting slot 220. The load is therefore uniformly distributed and resisted by the second connecting unit 200. Also, since each of the proximate end portion 120 and the connecting slot 220 has a non-circular cross section so as to prevent lateral rotational movement between the first connecting unit 100 and the second connecting unit 200.

Having described the invention by the description and illustrations above, it should be understood that these are exemplary of the invention and are not to be considered as limiting. Accordingly, the invention is not to be considered as limited by the foregoing description, but includes any equivalent.

What is claimed is:

1. A joint structure for furniture comprising a first connecting unit, a second connecting unit and a securing member,
wherein the first connecting unit has a distal end portion, a proximate end portion and a connecting surface formed on the proximate end portion;
wherein the second connecting unit has a coupling surface and a connecting slot formed on the coupling surface, and the proximate end portion of the first connecting unit configured to insert into the connecting slot of the second connecting member in a manner that the connecting surface of the first connecting unit biased against an inner wall of the connecting slot of the second connecting unit;
wherein the securing member include at least one coupling slot indentedly and longitudinally formed inside the first connecting unit, and at least one connecting shaft extended from the connecting slot of the second connecting member, and both the coupling slot and the connecting shaft are threaded, so when the connecting shaft is inserted into the coupling slot, the connecting shaft can be threadedly secured therein to interlock the first and second connecting units.

2. The joint structure for furniture of claim 1, wherein the securing member further includes an interlocking hole formed on the connecting surface to communicate with the coupling slot, and the connecting shaft is adapted to pass through the interlocking hole to be threadedly tightened within the coupling slot.
